(19) United States
(12) Patent Application Publication
(10) Pub. No.: US 2015/0201036 A1
(43) Pub. Date: Jul. 16, 2015

(54) GATEWAY DEVICE, FILE SERVER SYSTEM, AND FILE DISTRIBUTION METHOD

(71) Applicant: HITACHI, LTD., Tokyo (JP)

(72) Inventors: Kenya NISHIKI, Tokyo (JP); Naoki HARAGUCHI, Tokyo (JP); Yukiko TAKEDA, Tokyo (JP); Naokazu NEMOTO, Tokyo (JP)

(73) Assignee: HITACHI, LTD., Tokyo (JP)

(21) Appl. No.: 14/595,554

(22) Filed: Jan. 13, 2015

(30) Foreign Application Priority Data
Jan. 16, 2014 (JP) 2014-006135

(51) Int. Cl. H04L 29/08

(52) U.S. Cl. CPC H04L 67/2871; H04L 67/06

(57) ABSTRACT

A system high in availability which includes plural file servers and local disks is realized. A distributed file system has plural file server clusters that perform any one of file storage, file read, and file deletion according to a request. A gateway device mediates requests between a client device that transmits a request including any one of file storage, file read, and file deletion, and the distributed file system. The gateway device includes a health check function unit that monitors an operating status of the file server cluster, and a data control function unit that receives the request for the distributed file system from the client device, and selects one or more of the file server clusters that are normally in operation, and distributes the request to the selected file server clusters.

### CLAIM OF PRIORITY

The present application claims priority from Japanese patent application JP 2014-006135 filed on Jan. 16, 2014, the content of which is hereby incorporated by reference into this application.

### BACKGROUND

The present invention relates to a gateway device, a file server system, and a file distribution method.

In recent years, there is an approach that a large amount of data represented by big data is stored in a data center, and subjected to batch processing to obtain knowledge (information) useful for business. In the case of processing large amounts of data, the performance of a disk I/O (throughput) becomes an issue. Under the circumstances, in a distributed file system technology that is representative of a hadoop distributed file system (HDFS) of hadoop, large files are divided into small units (blocks), stored in local disks of plural servers, and read from the plural servers (disks) in parallel when reading the files to realize a high throughput (for example, refer to items of “Architecture”, “Deployment-Administrative commands”, “HDFS High Availability Using the Quorum Journal Manager”, [online], The Apache Software Foundation, [searched on Nov. 15, 2013], the Internet http://hadoop.apache.org/docs/current/hadoop-yarn/hadoop-yarn-site/HDFSHighAvailabilityWithQJM.html). On the other hand, in a service delivery platform of telecommunications carriers or a system control platform of social infrastructure operators in power or traffic, non-stop operation of the service is one of top priorities, and a failed server is disconnected and switched to a standby server in the event of a system failure, to thereby realize high reliability.

For example, in a technique disclosed in JP-A-2012-173996, there is proposed a method of preventing unnecessary service stop when split brain (abnormal operation by synchronous fraud between servers due to network failure) in a cluster system (for example, refer to the summary).

### SUMMARY

In a distributed file system, a large number of servers are coordinated for operation to realize distribution processing, and the processing performance can be improved with an increase in the number of servers. On the other hand, because the increase in the number of servers makes a possibility that a failure occurs high, even in a state where a part of the servers does not normally operate, there is required that the processing can be normally continued as the entire system.

The technique disclosed in “HDFS High Availability Using the Quorum Journal Manager”, [online], The Apache Software Foundation, [searched on Nov. 15, 2013], the Internet <http://hadoop.apache.org/docs/current/hadoop-yarn/hadoop-yarn-site/HDFSHighAvailabilityWithQJM.html>, the redundancy of a NameNode that manages metadata of the file system becomes an issue. For that reason, the technique includes an active NameNode server and a standby NameNode server, and when the NameNode is in failure, the server that is in an active state stops, and switches to the server that is in a standby state for processing to realize high reliability. However, in the technique disclosed in “HDFS High Availability Using the Quorum Journal Manager”, there is a risk that the service is interrupted during switching between the active server and the standby server, or the switching process fails to stop the service. Further, in order to apply the technique of “HDFS High Availability Using the Quorum Journal Manager”, because there is a need to update software of all the servers, there arises such a problem that operational costs (implementation costs) are large.

In the technique disclosed in JP-A-2012-173996, as described above, there is proposed a method of preventing unnecessary service stop when the split brain occurs in a cluster system. However, the technique of JP-A-2012-173996 suffers from such a problem that a shared storage is used to synchronization processing between the servers, but a failure of the shared storage is not considered. Further, the technique of JP-A-2012-173996 does not consider the redundancy of data, and cannot ensure the data availability of the distributed file system.

The present invention improves the availability of a system having a distributed file system including plural file servers and a local disk.

For example, it is provided a gateway device that mediates requests between a client device that transmits a request including any one of file storage, file read, and file deletion, and a distributed file system having a plurality, of file server clusters that perform file processing according to the request, the gateway device comprising:

a health check function unit that monitors an operating status of the file server cluster; and

a data control function unit that receives the request for the distributed file system from the client device, and selects one or more of the file server clusters that are normally in operation, and distributes the request to the selected file server clusters.

For another example, it is provided a file server system comprising:

a distributed file system having a plurality of file server clusters that perform any one of file storage, file read, and file deletion according to a request,

a gateway device that mediates requests between a client device that transmits the request including any one of file storage, file read, and file deletion, and the distributed file system

wherein the gateway device comprising:

a health check function unit that monitors an operating status of the file server cluster; and

a data control function unit that receives the request for the distributed file system from the client device, and selects one or more of the file server clusters that are normally in operation, and distributes the request to the selected file server clusters.

For another example, it is provided a file distribution method in a file server system, the file server system comprising:

a distributed file system having a plurality of file server clusters that perform any one of file storage, file read, and file deletion according to a request,

a gateway device that mediates requests between a client device that transmits the request including any one of file storage, file read, and file deletion, and the distributed file system

wherein the gateway device

monitors an operating status of the file server cluster, and

receives the request for the distributed file system from the client device, and selects one or more of the file server clusters that are normally in operation, and distributes the request to the selected file server clusters.

It is possible, according to the disclosure of the specification and figures, to improve the availability of a system having a distributed file system including plural file servers and a local disk.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an overall configuration example of a computer system (file server system) according to a first embodiment;

FIG. 2 is a diagram illustrating a configuration example of an application extension gateway device in the computer system according to the first embodiment;

FIG. 3 is a flowchart illustrating a processing step of a client API function unit provided in the application extension gateway device;

FIG. 4 is a flowchart illustrating a processing step of a cluster setting function unit provided in the application extension gateway device;

FIG. 5 is a flowchart illustrating a processing step of a health check function unit provided in the application extension gateway device;

FIG. 6 is a flowchart illustrating a processing step of a data control function unit provided in the application extension gateway device;

FIG. 7 is a flowchart illustrating a processing step of a data restore function unit provided in the application extension gateway device;

FIG. 8 is a diagram illustrating a configuration example of a table for managing cluster information held by the application extension gateway device;

FIG. 9 is a diagram illustrating a configuration example of a table for managing data policy information held by the application extension gateway device;

FIG. 10 is a diagram illustrating a configuration example of a table for managing data index information held by the application extension gateway device;

FIG. 11 is a diagram illustrating a configuration example of a table for managing a cluster distribution rule held by the application extension gateway device;

FIG. 12 s a diagram illustrating a configuration example of a table for managing a data restore rule held by the application extension gateway device;

FIG. 13 is a sequence diagram illustrating a processing flow example for creating a file through the application extension gateway device;

FIG. 14 is a sequence diagram illustrating a processing flow example for reading a file through the application extension gateway device;

FIG. 15 is a sequence diagram illustrating a processing flow example for deleting a file through the application extension gateway device;

FIG. 16 is a sequence diagram illustrating a processing flow example for searching a file through the application extension gateway device;

FIG. 17 is a diagram illustrating an API message example which is transmitted from a client to the application extension gateway device;

FIG. 18 is a diagram illustrating an overall configuration example of a computer system (file server system) according to a second embodiment;

FIG. 19 is a diagram illustrating a configuration example of an application extension gateway device in the computer system according to the second embodiment;

FIG. 20 is a flowchart illustrating a processing step of a cluster reconfiguration function unit provided in the application extension gateway device;

FIG. 21 is a diagram illustrating a configuration example of a table for managing a data reconfiguration rule held by the application extension gateway device;

FIG. 22 is a schematic sequence diagram of the gateway device according to the first embodiment.

### DETAILED DESCRIPTION OF THE EMBODIMENTS

This embodiment relates to a gateway system installed on a communication path between a terminal and a server device, a file server system having the gateway device, and a file distribution method in a network system that communicates data between the server devices in, for example, a world wide web (WWW), a file storage system, and a data center, and the terminal. Hereinafter, respective embodiments will be described with reference to the drawings.

### First Embodiment

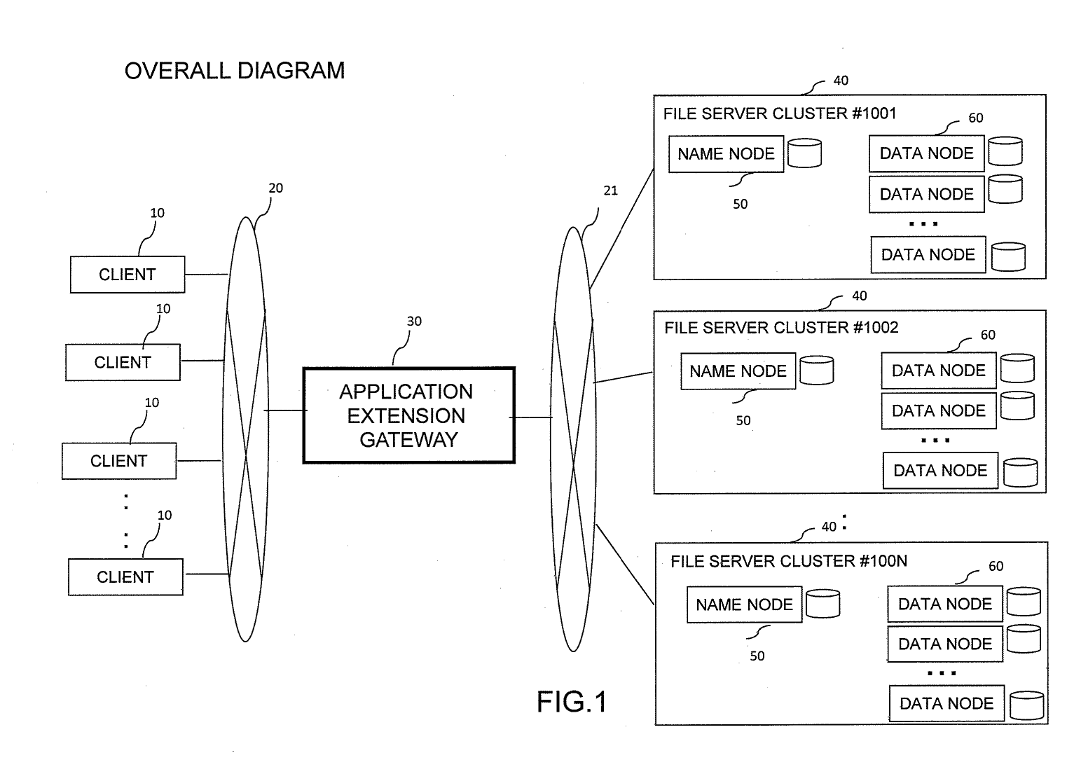

FIG. 1 is a diagram illustrating an overall configuration example of a computer system (file server system) according to a first embodiment.

A computer system (file server system) according to this embodiment includes one or plural client devices (hereinafter referred to merely as “client”) 10, one or plural application extension gateway device (hereinafter referred to also as “gateway device”) 30, and one or plural file server clusters 40, and the respective devices are connected to each other through networks 20 or 21.

Each of the clients 10 is a terminal that creates a file and/or executes an application referring to the file. The application extension gateway device 30 is a server that is installed between the clients 10 and the file server clusters 40, and implements a function unit program of this embodiment. For example, each of the clients 10 transmits a request including any one of file storage, file read, file deletion, and file search.

Each of the file server clusters 40 includes at least one name node 50 that manages metadata such as data location or status, and one or plural data nodes 60 that hold data, and one or plural file server clusters 40 to configure a distributed file system.

In this embodiment, the application extension gateway device 30 and the file server clusters 40 are configured by separate hardware. Alternatively, the application extension gateway device 30 and the file server clusters 40 may be configured to operate on the same hardware.

Also, in this embodiment, a configuration of the computer system having one application extension gateway device 30 will be described. Alternatively, the computer system may have plural gateway devices 30. In this case, information is shared or synchronization is performed among the plural gateway devices 30.

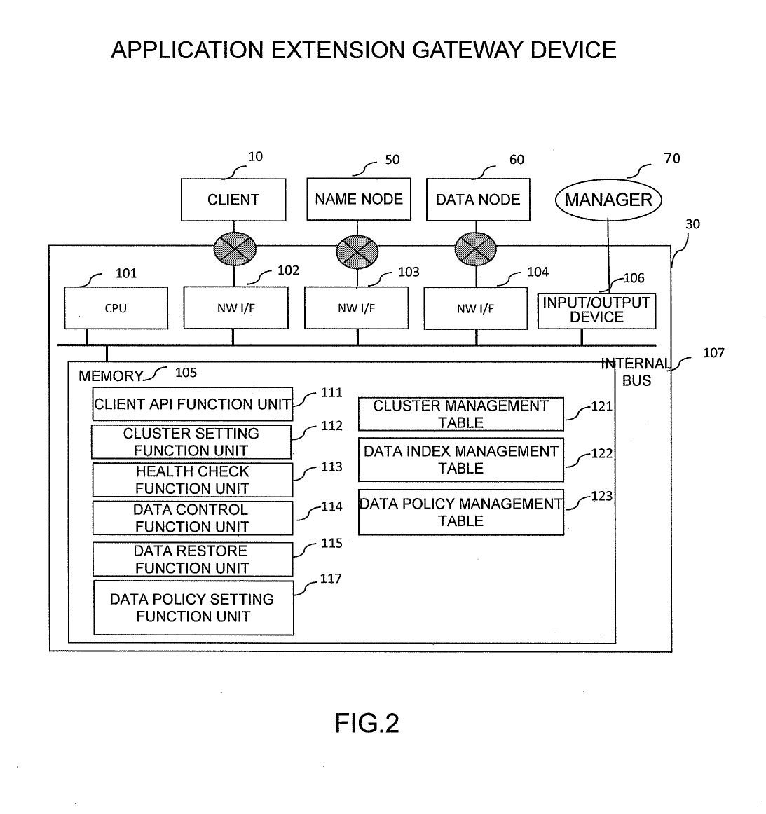

FIG. 2 is a diagram illustrating a configuration example of the gateway device 30.

The gateway device 30 includes, for example, at least one CPU 101, at least one network interfaces (NW I/F) 102 to 104, an input/output device 106, and a memory 105. The respective units are connected to each other through a communication path 107 such as an internal bus, and realized on a computer. The NW I/F 102 is connected to the client 10 through the network 20. The NW I/F 103 is connected to the name node 50 of a file server cluster through the network 21. The NW I/F 104 is connected to the data node 60 of the file server cluster through the network 21. In the memory 105 are stored the respective programs of a client API function unit 111, a cluster setting function unit 112, a health check function unit 113, a data control function unit 114, a data restore function unit 115, and a data policy setting function unit 117, which will be described below, and a cluster management table 121, a data index management table 122, and a data policy management table 123 therein. The respective programs are executed by the CPU 101 to realize the operation of the respective function units. The respective tables may not be of a table form, or may be an appropriate storage region.

The respective programs may be stored in the memory 105 of the gateway device 30 in advance, or may be introduced into the memory 105 through a recording medium available by the gateway device 30 when needed. The recording medium means, for example, a recording medium detachably attached to the input/output device 106, or a medium through a communication medium (that is, a network such as wired, wireless, or light which is connected to the NW I/F 102 to 104, or a carrier wave or a digital signal which propagates through the network).

The input/output device 106 includes, for example, an input unit that receives data according to the operation of a manager 70, and a display unit that displays data. The input/output device 106 may be connected to an external management terminal operated by the manager so as to receive data from the management terminal, or output data to the management terminal.

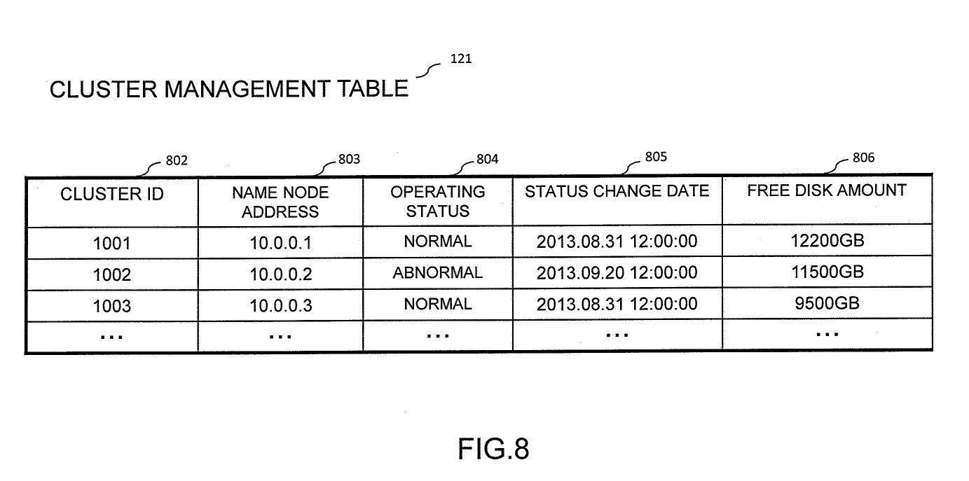

FIG. 8 illustrates an example of the cluster management table 121 provided in the gateway device 30. In the cluster management table 121 are registered, for each of the clusters, for example, a cluster ID 802 that identifies the cluster, a name node address 803 which is a network address (for example, IP address) of the cluster, an operating status 804 indicative of whether the cluster is normal or abnormal, a status change date 805 which is date when the operating state is updated, and a free disk amount 806 which can be stored in the cluster. The free disk amount 806 may be updated by inquiring the name 1Q node of the cluster at appropriate timing such as at the time of health check, or may be increased or decreased at the time of deletion and write of data.

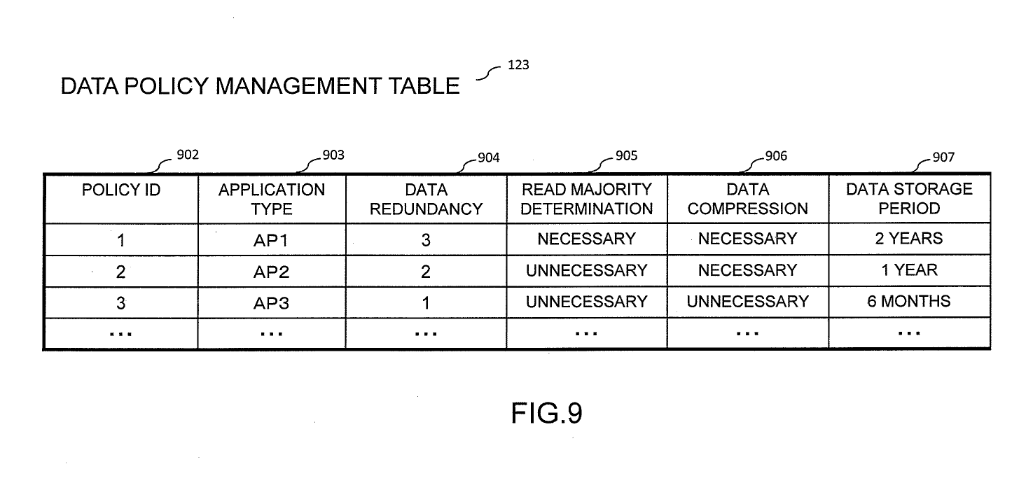

FIG. 9 illustrates an example of the data policy management table 123 provided in the gateway device 30. In the data policy management table 123 are registered, for example, a policy ID 902 that identifies a policy, an application type 903 such as a character string or an identification number indicative of the type of an application, a data redundancy 904 indicative of how many data copies are held, read majority determination information 905 for determining whether data is correct, or not, according to majority when reading data, data compression information 906 indicative of whether data compression is applied when storing data, or not, and data storage period 907 indicative of a period during which the data is stored. If the capacity is short when a file of a certain application type is written into the data node, a file that exceeds the data storage period 907 is deleted to ensure the capacity, and the files can be stored. The respective data can be set by the data policy setting function unit 117 on the basis of data input by the operation of the manager.

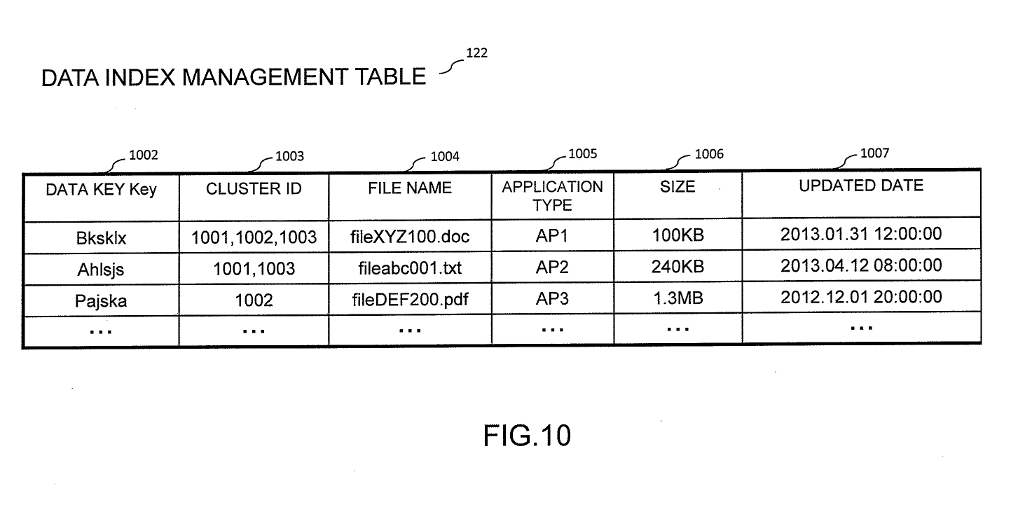

FIG. 10 illustrates an example of the data index management table 122 provided in the gateway device 30. In the data index management table 122 are registered, for example, a data key (for example, a hash value obtained from a file path and a file name) 1002 for identifying the file, a cluster ID 1003 of one or plural clusters in which the files are held, a file name 1004, an application type 1005, a file size 1006, and updated date 1007 of the file. The data key and the file name are file identification information for identifying the files, and the cluster ID 1003, the application type 1005, the file size 1006, and the file updated date 1007 are file information associated with the files.

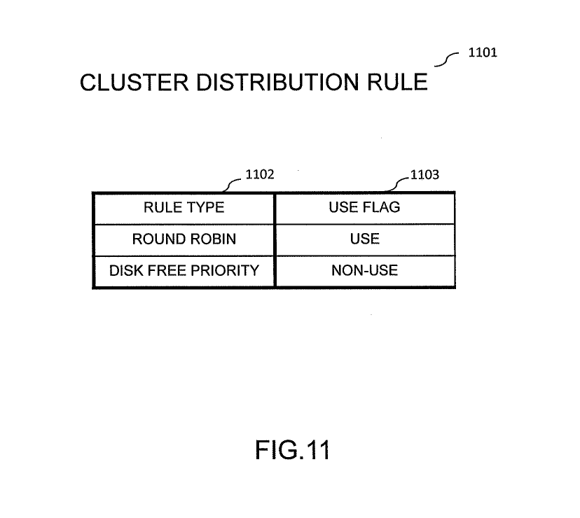

FIG. 11 illustrates an example of a cluster distribution rule 1101 stored in the memory 105 of the gateway device 30. The cluster distribution rule 1101 includes a rule type 1102, and a flag 1103 indicative of any one of use or non-use of the rule. The rule type 1102 can include, for example, a round robin for sequentially selecting the clusters, and disk free priority for selecting the clusters larger in the free disk amount with priority. The rule type 1102 is not limited to those examples, but may employ appropriate manners. The use flag can be appropriately changed in setting by a setting unit (not shown).

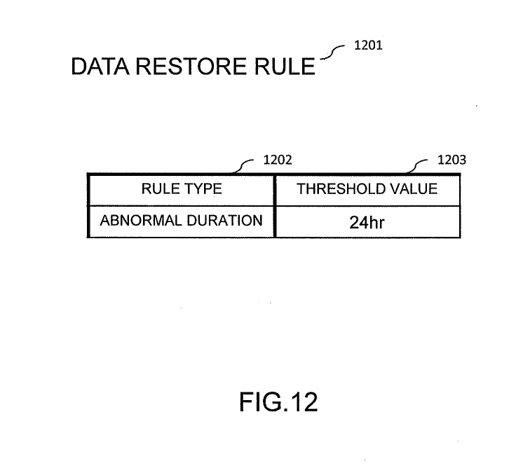

FIG. 12 illustrates an example of a data restore rule 1201 stored in the memory 105 of the gateway device 30. The data restore rule 1201 includes a rule type 1202, and a threshold value 1203 for determining whether data restore is applied, or not. In this embodiment, whether data restore is applied, or not, according to an abnormal duration, and 24 hours are stored as an example of the threshold value 1203. With the exception of the determination by the abnormal duration, an appropriate applied rule may be determined, and registered in the rule type. The threshold value 1203 may be an appropriate criterion for determination or condition other than the threshold value.

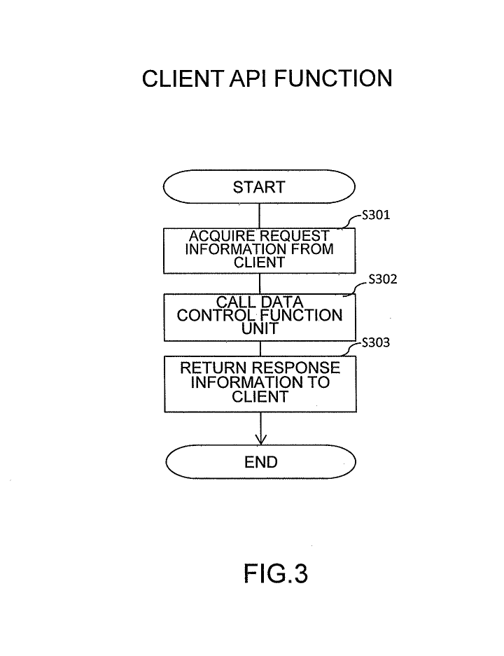

FIG. 3 illustrates an example of a processing step of the client API function unit 111 provided in the gateway device 30. The client API function unit 111 acquires request information for the file server clusters 40 from the client 10 (S301). Then, the client API function unit 111 calls the data control function unit 114, and receives processing results obtained by the data control function unit 114 (S302). For example, the client API function unit 111 receives, for example, a file creation result, a file read result, a file deletion result, or a file search result. The processing of the data control function unit 114 will be described later. Also, the client API function unit 111 returns response information to the request information to the client 10 on the basis of the received processing results (S303).

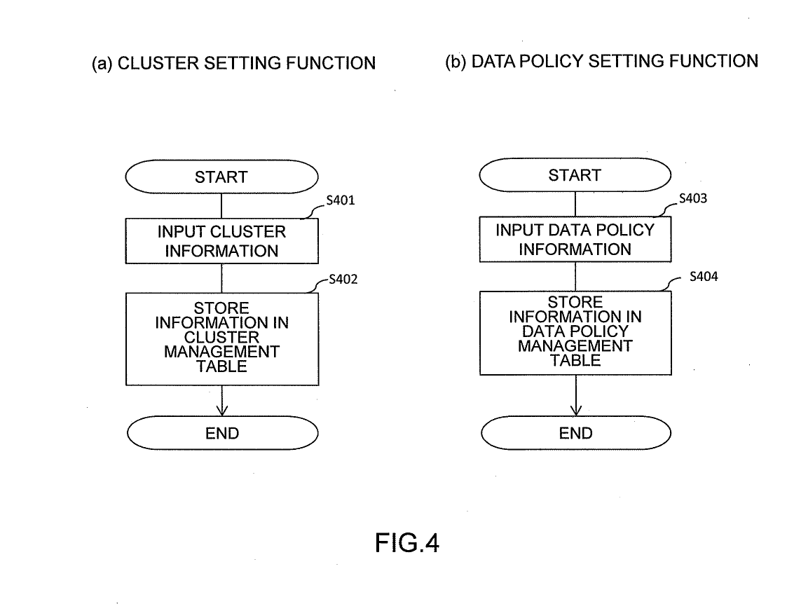

FIG. 4A illustrates an example of a processing step in the cluster setting function unit 112 provided in the gateway device 30. The cluster setting function unit 112 receives cluster information from the input/output device 106 according to the operation of the manager (S401). The input cluster information includes, for example, one or plural pairs of cluster ID and name node address. Also, the cluster information may further include a disk capacity corresponding to the cluster ID. The cluster setting function unit 112 stores the input cluster information in the cluster management table 121 (S402).

FIG. 4B illustrates an example of a processing step in the data policy setting function unit 117 provided in the gateway device 30. The data policy setting function unit 117 receives data policy information from the input/output device 106 by the operation of the manager (S403). The data policy information to be received includes, for example, a policy ID, an application type, a data redundancy, read majority determination information, data compression information, and data storage period. The data policy setting function unit 117 stores the input data policy information in the data policy management table 123 (S404).

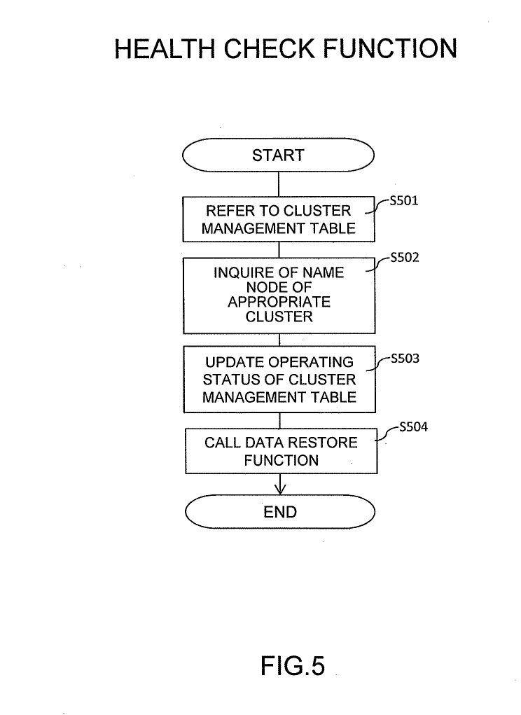

FIG. 5 illustrates an example of a processing step in the health check function unit 113 provided in the gateway device 30. The health check function unit 113 acquires the name node address of the cluster with reference to the cluster management table 121 (S501), and inquires the name nodes of the respective clusters (S502). For example, the health check function unit 113 transmits a health check packet to the name nodes. Then, the health check function unit 113 updates the operating status (for example, normal or abnormal) in the cluster management table 121 according to response results to the inquiry (S503). The health check function unit 113 calls the data restore function unit 115 (S504). In Stop S504, the health check function unit 113 calls the data restore function, to thereby determine whether data restore to be described later is necessary, or not, at timing of health check, but Step S504 may be omitted. The processing of the function unit 113 may be explicitly called by the manager, or periodically called with the use of a scheduler of the OS.

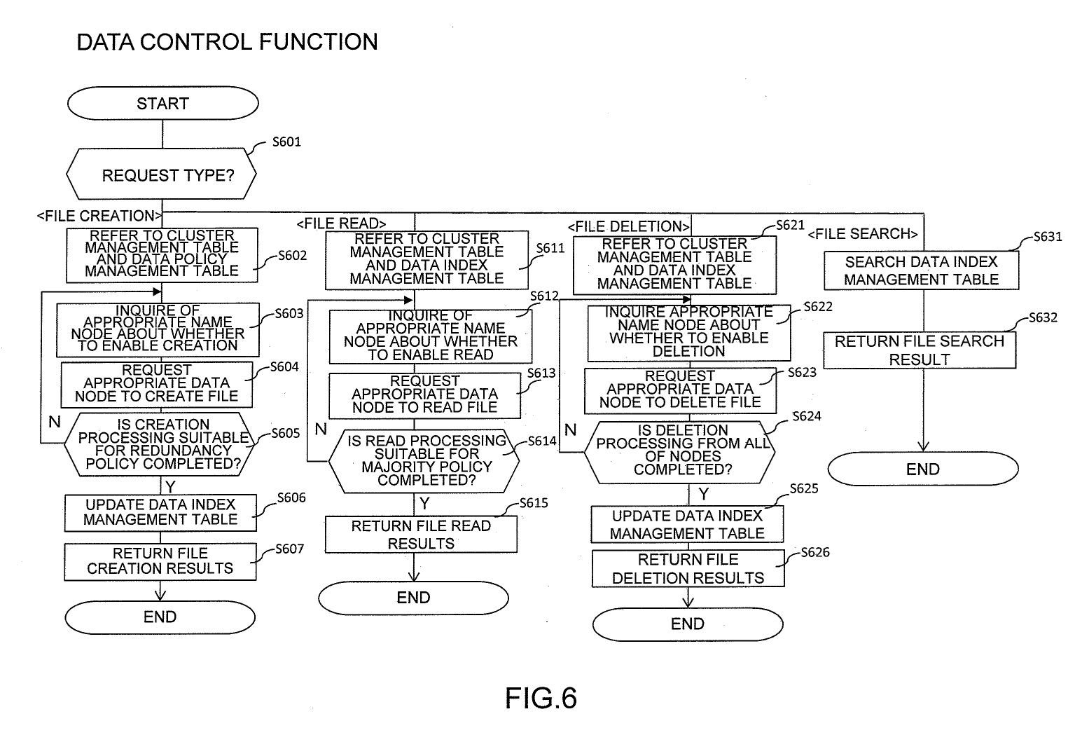

FIG. 6 illustrates an example of a processing step in the data control function unit 114 provided in the gateway device 30. The processing of the data control function unit 114 is executed, for example, with an opportunity that the client API function unit 111 acquires the request from the client 10.

The data control function unit 114 distributes the following processing according to a request type from the client 10 (S601).

First, the file creation will be described. If the request type is <file creation>, the data control function unit 114 selects the cluster that stores the file with reference to the cluster management table 121 and the data policy management table 123, and acquires the name node address of the selected cluster (S602). For example, the data control function unit 114 acquires the corresponding data redundancy 904 with reference to the data policy management table 123 on the basis of the application type included in the request from the client 10. Also, the data control function unit 114 selects the clusters of the number corresponding to the data redundancy from the clusters indicating that the operating status 804 is normal with reference to the cluster management table 121. The selection manner of the clusters is performed according to the cluster distribution rule 1101 illustrated in FIG. 11. The data control function unit 114 acquires the name node address 803 of the selected cluster.

The data control function unit 114 inquires of the name node of the selected cluster about whether to enable the file creation according to the acquired name node address (S603). If the data control function unit 114 receives a response that the file can be created from the name node, the data control function unit 114 requests an appropriate data node to create the file (S604). The data control function unit 114 acquires the file from the client 10 at appropriate timing, and transfers the file to the data node. On the other hand, except for the case where the data control function unit 114 receives the response that the file can be created from the name node, the data control function unit 114 selects another cluster. The manner of selecting the clusters is identical with the above-mentioned manner. The exclusion of the case in which the file can be created from the name node includes a case in which the data control function unit 114 receives a response that the permission of the file creation is difficult from the name node due to the capacity shortage of the cluster, and a case in which there is no response from the name node.

The data control function unit 114 repeats the processing of Steps S603 and S604 until the file creation processing suitable for the data redundancy policy is completed (S605). Upon the completion of the file creation processing, the data control function unit 114 updates the data index management table 122 (S606). For example, the data control function unit 114 obtains the data key from the file name, and stores the data key, the cluster ID of one or plural clusters that store the files, the file name, the application type, the file size, and the updated date in the data index management table 122. Also, the data control function unit 114 returns the file creation results to the client API function unit 111 (S607). The file creation results include, for example, the completion of the file creation, and the cluster that has created the file. The file creation results are transmitted to the client 10 through the client API function unit 111.

If the request type is <file read> (S601), the data control function unit 114 acquires the name node address of the cluster in which the file to be read is stored with reference to the cluster management table 121 and the data index management table 122 (S611). For example, the data control function unit 114 acquires the corresponding application type 1005 and cluster ID 1003 with reference to the data index management table 122 on the basis of the file name included in the request from the client 10. Also, the data control function unit 114 acquires the corresponding read majority determination information 905 with reference to the data policy management table 123 on the basis of the acquired application type. Further, the data control function unit 114 acquires the corresponding name node address 803 with reference to the cluster management table 121 on the basis of the acquired cluster ID.

The data control function unit 114 inquires of the name node of the selected cluster about whether to enable the file read according to the acquired name node address (S612). If the data control function unit 114 receives the response that the file can be read from the name node, the data control function unit 114 requests the data node of the appropriate cluster to read the file (S613). As a result, the data control function unit 114 reads the file from the data node. On the other hand, except for the case where the data control function unit 114 receives the response that the file can be read from the name node, the data control function unit 114 selects another cluster from the clusters that store the target file, and repeats Step S612. For example, another cluster ID is selected from the cluster IDs acquired with reference to the data index management table 122. The data control function unit 114 repeats the processing in Steps S612 and S613 until the file read processing suitable for a majority determination policy is completed (S614).

When the majority determination policy is applied, the data control function unit 114 reads the file from the plural data nodes, and if the number of files having the same contents is, for example, the majority of the acquired total number, the data control function unit 114 determines that the read processing is completed. The identity of the files can be checked by calculating a hash value such as MD5, and determining whether or not the files are identical. Upon the completion of the file read processing, the data control function unit 114 returns the file read results to the client API function unit 111 (S615). The file read results include, for example, the read files. The file read results are transmitted to the client 10 through the client API function unit 111.

Also, if the request type is <file deletion>, the data control function unit 114 acquires the name node address of the cluster in which the file to be deleted is stored with reference to the cluster management table 121 and the data index management table 122 (S621). For example, the data control function unit 114 acquires the corresponding cluster ID 1003 with reference to the data index management table 122 on the basis of the file name included in the request from the client 10. Also, the data control function unit 114 acquires the corresponding name node address 803 with reference to the cluster management table 121 on the basis of the acquired cluster ID.

The data control function unit 114 inquires of the name node of the selected cluster about whether to enable the file deletion according to the acquired name node address (S622). When receiving the response that the file deletion is enabled from the name node, the data control function unit 114 requests the appropriate data node to delete the file (S623). As a result, the data control function unit 114 deletes the file from the data node in which the file is stored. On the other hand, except for the case where the data control function unit 114 receives the response that the file can be deleted from the name node, the data control function unit 114 selects another cluster. The data control function unit 114 repeats Steps S622 and S623 until the file deletion processing is completed from the node that holds the data (S624). Upon the completion of the file deletion processing, the data control function unit 114 updates the data index management table 122 (S625). For example, the data control function unit 114 deletes the entry of the file name to be deleted. Also, the data control function unit 114 returns the file deletion results (S626). The file deletion results include, for example, information indicating that the file is correctly deleted. If there is a cluster in which the file could not be deleted, the identification information on the cluster may be included in the file deletion results. The file deletion results are transmitted to the client 10 through the client API function unit 111.

Also, if the request type is <file search>, the data control function unit 114 searches the data index management table 122 according to the search condition included in the request information (S631). The search condition includes, for example, the designation of the file name, the designation of the size, or a range designation of the updated date, but maybe other conditions. For example, if the search condition is the designation of the file name, the data control function unit 114 acquires the respective pieces of information (identification information on the file, and the above-mentioned file information) on the appropriate entry with reference to the data index management table 122 on the basis of the file name included in the request information. Then, the data control function unit 114 returns the file sear results to the client API function unit 111 (S632). The file search results include, for example, the respective pieces of information on the appropriate entry acquired from the data index management table 122. The file search results are transmitted to the client 10 via the client API function unit 111.

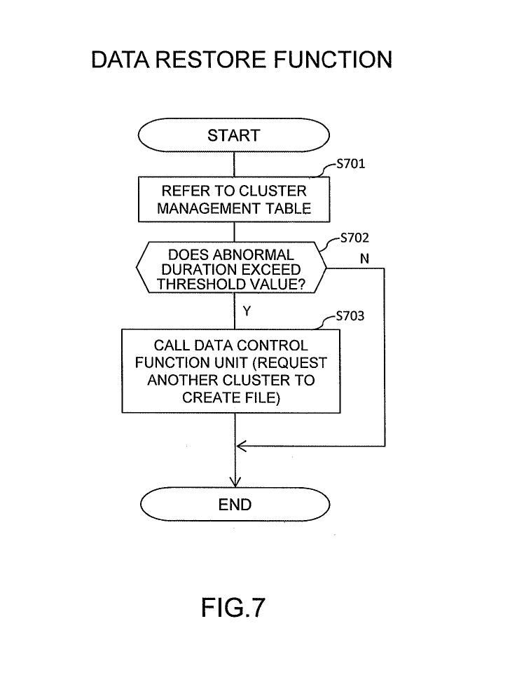

FIG. 7 illustrates an example of a processing step in the data restore function unit 115 provided in the gateway device 30. The data restore function unit 115 refers to the cluster management table 121 (S701) in which “abnormality” is stored as the operating status in each of the clusters, and determines whether an elapsed time (abnormal duration) from a status change date exceeds a threshold value stored in the data restore rule illustrated in FIG. 12, or not (S702). If any cluster in which the elapsed time exceeds the threshold value (hereinafter referred to as “abnormal duration cluster”) is present, the data restore function unit 115 calls the data control function unit 114, and executes the file creation processing suitable for the policy (S703). For example, in order to ensure the data redundancy of the file stored in the appropriate cluster, the data restore function unit 115 calls the data redundancy from a cluster other than the abnormal duration cluster, and stores the data redundancy into another cluster.

Specifically, the data restore function unit 115 searches the entry in which the cluster ID of the abnormal duration cluster (first file server cluster) is registered with reference to the cluster ID of the data index management table 122. The data restore function unit 115 acquires the corresponding data redundancy with reference to the data policy management table 123 on the basis of the application type 1005 of the appropriate entry. If the plural data redundancies are present, the abnormal direction cluster is in an abnormal state, to thereby reduce the redundancy. Therefore, the data restore function unit 115 again refers to the appropriate entry of the data index management table 122, and specifies the cluster ID other than the abnormal duration cluster. The data restore function unit 115 reads the file from the cluster (second file server cluster) indicated by the specified cluster ID in the same manner as that of the file read processing illustrated in FIG. 6. Alternatively, the data restore function unit 115 may read the file from another appropriate device. Also, the data restore function unit 115 writes the read file into another cluster (third file server cluster) different from the cluster ID 1003 of the appropriate entry of the data index management table 122 in the same manner as that of the file creation processing illustrated in FIG. 6.

The processing of the data restore function unit 115 is called by the health check function unit 113, but may be executed by another appropriate trigger, or may be periodically executed.

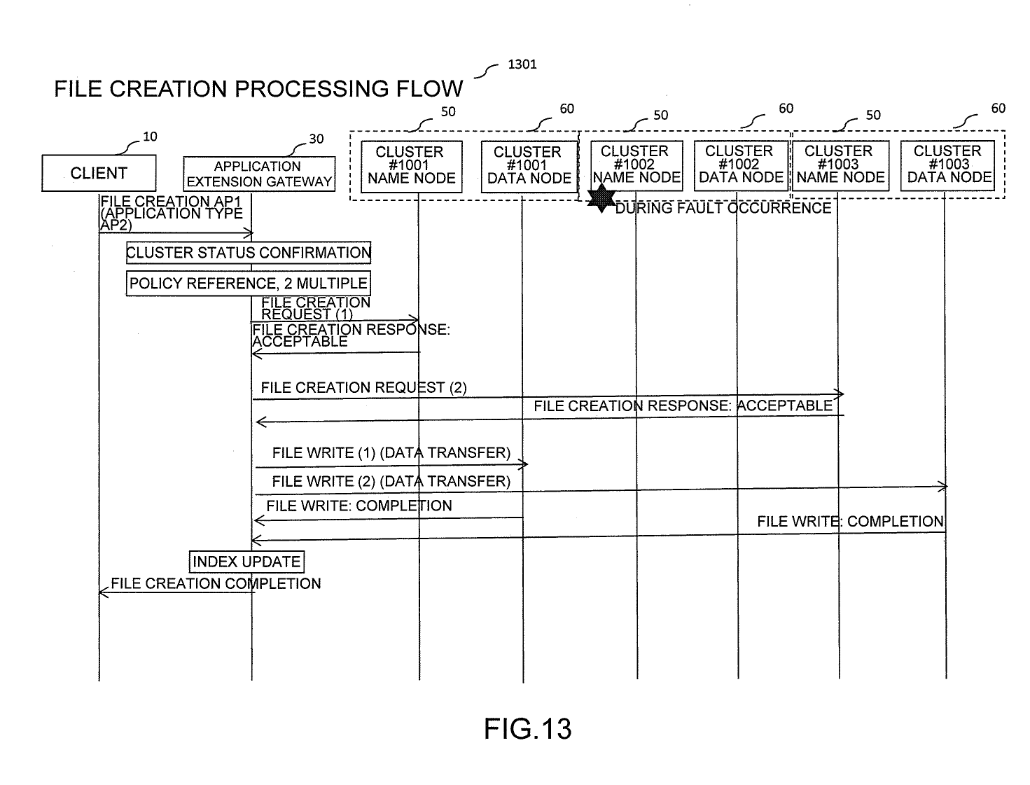

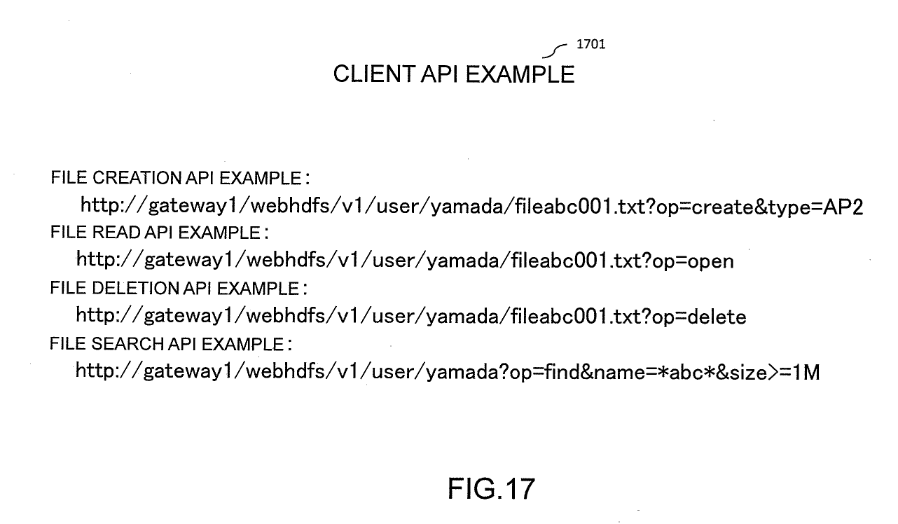

FIG. 13 illustrates an example of a processing flow 1301 in which the gateway device 30 receives a file creation API request from the client 10, and creates the file in the clusters #1001 and #1003. In this example, a fault occurs in the name node of the cluster #1002. After receiving the file creation API request, the following processing is executed in the gateway device 30. An example of the file creation API request is illustrated in FIG. 17 (http://gateway1/webhdfs/v1/user/yamada/fileabc001.txt?op=create&type=AP2). The file creation API request includes, for example, the file name, the request type, and the application type.

First, the gateway device 30 refers to the cluster management table 121 illustrated in FIG. 8, and acquires that a fault occurs in the cluster #1002. Then, the gateway device 30 refers to the data policy management table 123 illustrated in FIG. 9, and acquires that a multiplicity (data redundancy) of the data is 2 if the application type is AP2. Then, for example, the normal clusters #1001 and #1003 are selected as candidates by the gateway device 30, a file creation request is transmitted to the name nodes of the respective clusters. If the gateway device 30 receives that a file creation response is acceptable from the name node, the gateway device 30 writes the file into the designated data node. If the write into the two data nodes is successful (if a completion notification of the file write is received), the gateway device 30 updates the contents of the data index management table 122, and notifies the client of the file creation completion.

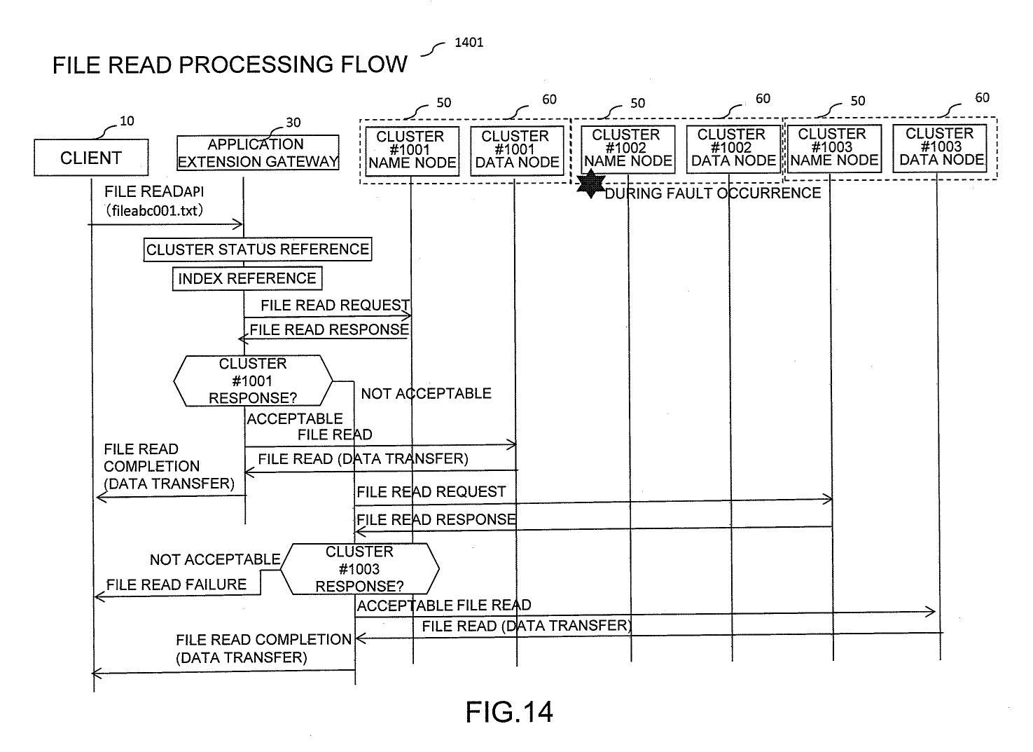

FIG. 14 illustrates an example of a processing flow 1401 in which the gateway device 30 receives a file read API request from the client 10, and reads the file from the cluster #1001 or #1003. In this example, a fault occurs in the name node of the cluster #1002. After receiving the file read API request, the following processing is executed in the gateway device 30. An example of the file read API request is illustrated in FIG. 17 (http://gateway1/webhdfs/v1/user/yamada/fileabc001.txt?op=open). The file read API request includes, for example, the file name to be read, and the request type.

First, the gateway device 30 refers to the cluster management table 121 illustrated in FIG. 8, and acquires that the fault occurs in the cluster #1002. Then, the gateway device 30 refers to the data index management table 122 illustrated in FIG. 10, and acquires that the file to be read is stored in the clusters #1001 and #1003. The gateway device 30 transmits a file read request to the name node of the cluster #1001, and if a response to the file read request is “acceptable”, the gateway device 30 executes the file read for the appropriate data node, and acquires the file. Also, the gateway device 30 transfers the read file to the client 10, and completes read. On the other hand, if the response of the name node #1001 is “not acceptable”, the gateway device 30 transmits a file read request to the name node #1003, and if the response is “acceptable”, the gateway device 30 executes the file read for the appropriate data node, and acquires the file. If the response of the name node #1003 is “not acceptable”, the gateway device 30 notifies the client 10 of the file read failure.

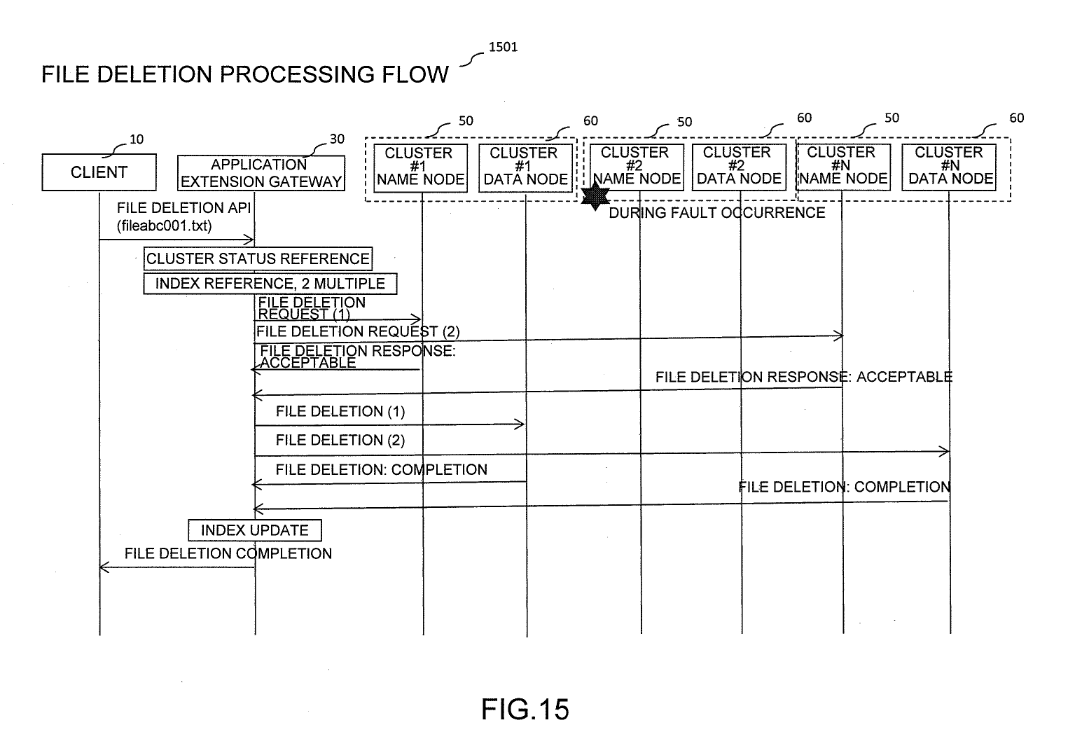

FIG. 15 illustrates an example of a processing flow 1501 in which the gateway device 30 receives a file deletion API request from the client 10, and deletes the file from the clusters #1001 and #1003. In this example, a fault occurs in the name node of the cluster #1002. After receiving the file deletion API request, the following processing is executed in the gateway device 30. An example of the file deletion API request is illustrated in FIG. 17 (http://gateway1/webhdfs/v1/user/yamada/fileabc001.txt?op=delete). The file deletion API request includes, for example, the file name to be deleted, and the request type.

First, the gateway device 30 refers to the cluster management table 121 illustrated in FIG. 8, and acquires that the fault occurs in the cluster #1002. Then, the gateway device 30 refers to the data index management table 122 illustrated in FIG. 10, and acquires that the file is stored in the clusters #1001 and #1003.

The gateway device 30 transmits a file deletion request to the name node of the clusters #1001 and #1003, and if a response to the file deletion request is “acceptable”, the gateway device 30 executes the file deletion for the appropriate data node, and deletes the file. Also, the gateway device 30 notifies the client 10 of the file deletion completion.

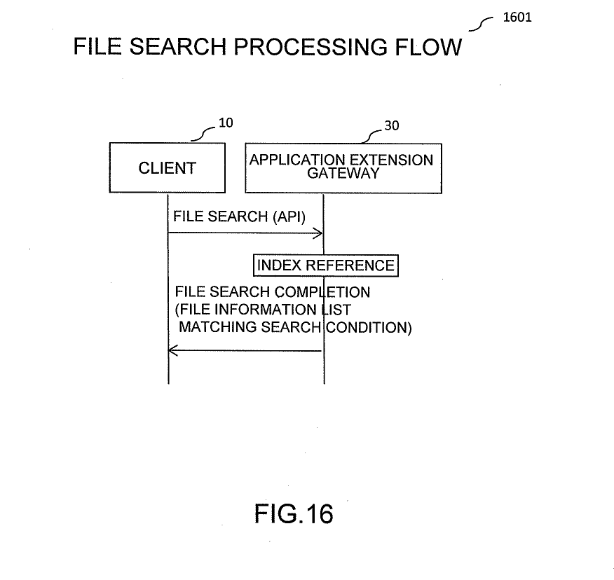

FIG. 16 illustrates an example of a processing flow 1601 in which the gateway device 30 receives a file search API request from the client 10, and searches a file list that conforms to the search condition. An example of the file search API request is illustrated in FIG. 17 (http://gateway1/webhdfs/v1/user/yamada?op=find&name=*abc*&size>=1M). The file search API request includes, for example, the request type, and the search condition. In the example of FIG. 17, the search condition includes a condition for searching a file in which a file name contains abc, and a size is 1 MB or higher.

After receiving the file search API request, the gateway device 30 first searches the data index management table 122 illustrated in FIG. 10, and acquires a file information list that conforms to the condition. Also, the gateway device 30 notifies the client 10 of the file search completion.

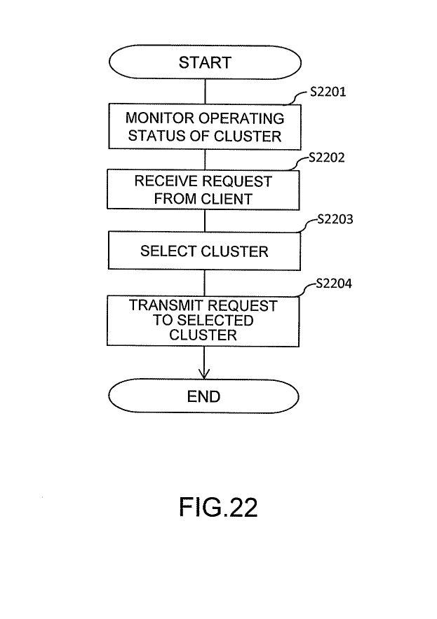

FIG. 22 is a schematic sequence diagram of the gateway device according to this embodiment.

The health check function unit 113 of the gateway device 30 monitors the operating status of the file server clusters 40 (S2201). Also, the data control function unit 114 of the gateway device 30 receives the request for the distributed file system from the client device (S2202). The data control function unit 114 of the gateway device 30 selects one or more file server clusters 40 that are normally in operation (S2203). Also, the data control function unit 114 of the gateway device 30 distributes the request to the selected file server clusters 40 for transmission (S2204).

According to this embodiment, in the system where the distributed file system configured by the plural client terminals, servers, and local disks exchanges a large amount of data, the availability of the overall system can be improved.

Also, according to this embodiment, the application extension gateway device can select an appropriate server that processes data along a level required by the application in response to the request to the distributed file system, and implement distribution processing of data. Also, the application extension gateway device distributes and manages data and the meta information of data along the level required by the application by the plural servers, thereby being capable of executing data processing without stopping the service when a fault occurs in the server or the local disk.

Further, according to this embodiment, the application extension gateway device can be introduced without changing the server software of the distributed file system. Further, in the gateway device, the management policy of data can be flexibly set and executed according to the application type, and an additional function unit such as the file search function unit can be added.

Also, according to this embodiment, no high-performance server is required, no software that manages a large amount of data is required, and the introduction is easy. On the other hand, in order to ensure neglected reliability, the same processing is executed by the plural servers in parallel, and data is made redundant, thereby being capable of maintaining the high reliability.

### Second Embodiment

In the first embodiment, a case in which the plural file server clusters are configured in advance, and the data may be distributed as it is has been described. In a second embodiment, a data migration method in which only one file server cluster is present in an initial stage, and data not distributed is present will be described.

A portion after data has been migrated is identical with that in the first embodiment. For that reason, in this embodiment, differences from the first embodiment will be mainly described.

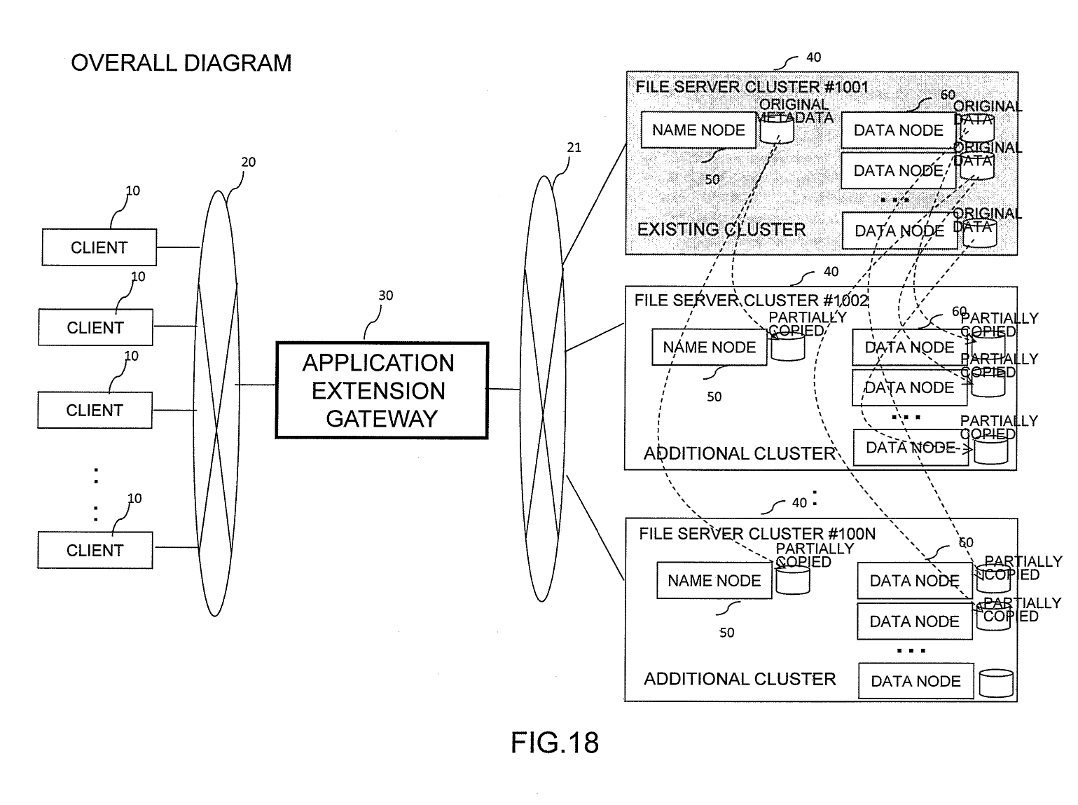

FIG. 18 illustrates an example of the overall configuration of a system according to a second embodiment. In the initial stage, data is stored in the cluster #1001 (fourth file server cluster), and a part of data in the cluster #1001 is copied to clusters #1002 and #1003 (fifth file server cluster) which are newly added, to thereby perform data redundancy by the plural clusters. No file is normally stored in the clusters #1002 and #1003 newly added, but some file may be stored therein.

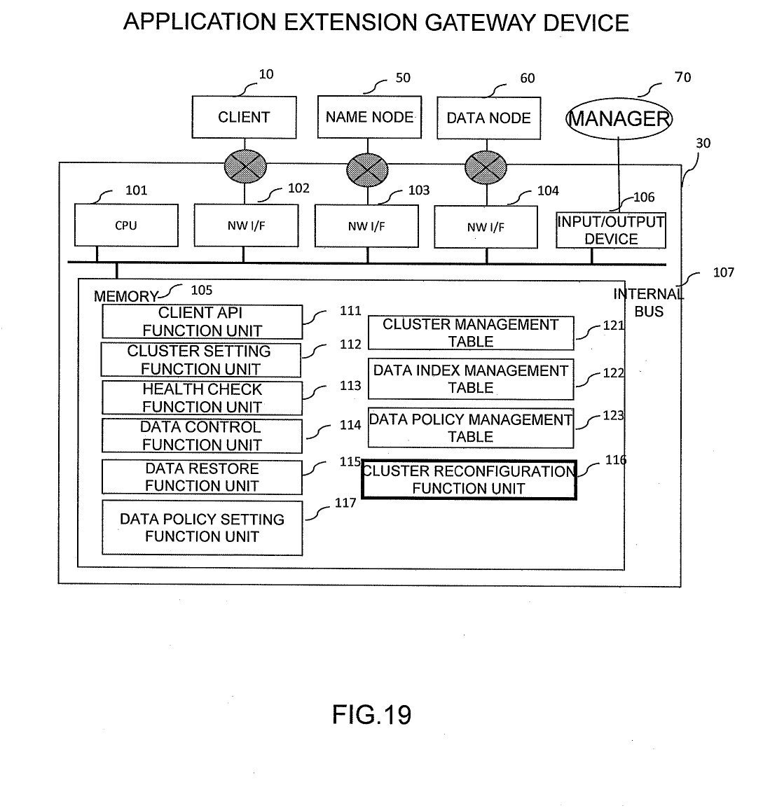

FIG. 19 illustrates an example of a configuration of a gateway device according to a second embodiment. The gateway device 30 according to the second embodiment further includes a cluster reconfiguration function unit 116, and data migration processing is performed by the cluster reconfiguration function unit 116.

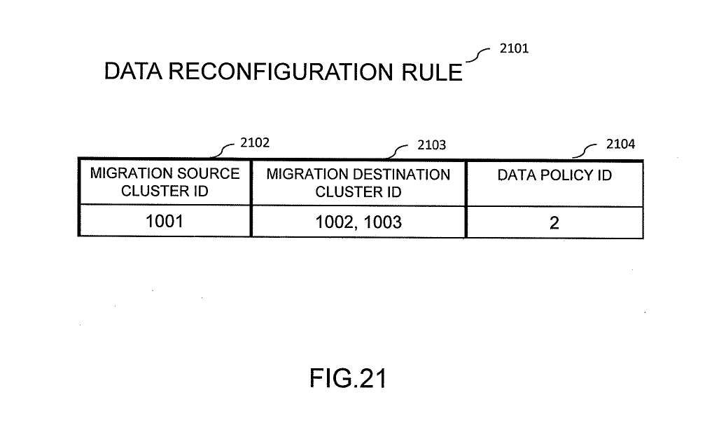

FIG. 21 is a diagram illustrating a configuration example of a table for managing a data reconfiguration rule held by the application extension gateway device. The data reconfiguration rule is predetermined, and stored in the memory 105. For example, the data reconfiguration rule includes a migration source cluster ID 2102 of the file, one or plural migration destination clusters ID 2103, and a data policy ID 2104. The data policy ID 2104 corresponds to the policy ID 902 stored in the data policy management table 123 illustrated in FIG. 9. In this example, any one of the plural policies stored in the data policy management table 123 is selectively used, and the setting can be simplified by selection from the existing policies. A new policy may be set.

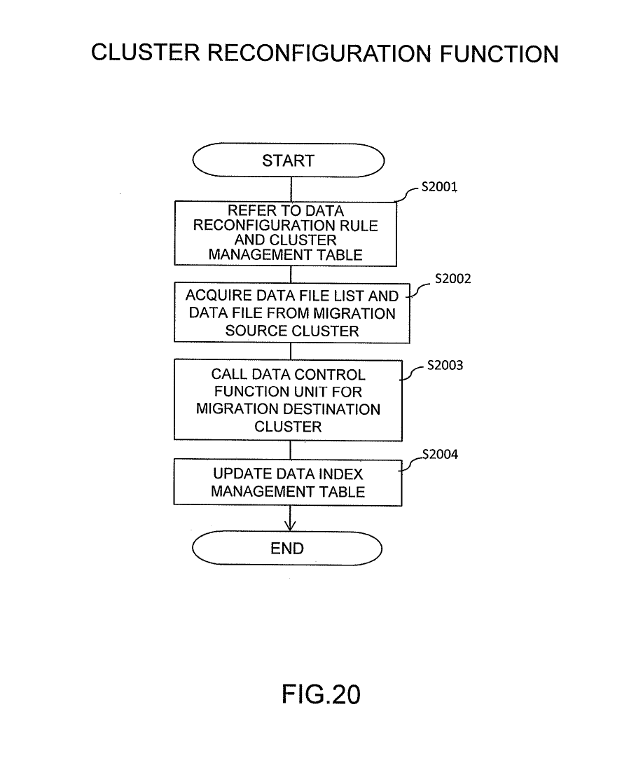

FIG. 20 illustrates an example of processing steps of the cluster reconfiguration function unit 116 provided in the gateway device 30. The cluster reconfiguration function unit 116 refers to a data reconfiguration rule 2101 illustrated in FIG. 21, and the cluster management table 121 illustrated in FIG. 8 (S2001), and acquires a list of the data file, and the data files from the migration source cluster #1001 (S2002). Then, the cluster reconfiguration function unit 116 calls the data control function unit 114 from the migration destination clusters #1002 and #1003 to execute file creation processing in the same manner as that in the first embodiment (S2003). In this situation, the policy of the data policy ID=2 in FIG. 21 is applied. In this example, because the data redundancy is 2, the data file of the migration source cluster #1001 is copied, and appropriately distributed to the migration destination clusters #1002 and #1003. Also, the cluster reconfiguration function unit 116 updates the data index management table 122 for the migrated file (S2004). The updating technique is identical with that of the file write processing in the first embodiment.

According to this embodiment, data can be migrated from the system having only one file server cluster to the distributed system by the gateway device. Also, after migration, processing in the gateway device in the first embodiment can be applied. In the above example, a case in which only one file server cluster is provided has been described. Also, the present invention can be applied to a case in which a new file server cluster is provided in a system having plural file server clusters.

The present invention is not limited to the above embodiments, but includes various modified examples. For example, in the above-mentioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

Also, parts or all of the above-described respective configurations, functions and processors may be realized, for example, as an integrated circuit, or other hardware. Also, the above respective configurations and functions may be realized by allowing the processor to interpret and execute programs for realizing the respective functions. That is, the respective configurations and functions may be realized by software. The information on the program, table, and file for realizing the respective functions can be stored in a storage device such as a memory, a hard disc, or an SSD (solid state drive), or a storage medium such as an IC card, an SD card, or a DVD.

Also, the control lines and the information lines necessary for description are illustrated, and all of the control lines and the information lines necessary for products are not illustrated. In fact, it may be conceivable that most of the configurations are connected to each other.

Although the present disclosure has been described with reference to example embodiments, those skilled in the art will recognize that various changes and modifications may be made in form and detail without departing from the spirit and scope of the claimed subject matter.

What is claimed is:

1. A gateway device that mediates requests between a client device that transmits a request including any one of file storage, file read, and file deletion, and a distributed file system having a plurality of file server clusters that perform file processing according to the request, the gateway device comprising:
a health check function unit that monitors an operating status of the file server cluster; and
a data control function unit that receives the request for the distributed file system from the client device, and selects one or more of the file server clusters that are normally in operation, and distributes the request to the selected file server clusters.

2. The gateway device according to claim 1, further comprising: a data policy storage region in which a data redundancy is set,
wherein, upon receiving the request for the file storage, the data control function unit selects the plurality of file server clusters of the number corresponding to the data redundancy, and transmits the request to the respective file server clusters to store the file in the respective file server clusters.

3. The gateway device according to claim 2,
wherein the data policy storage region has the data redundancy set for each of the application types,
the request for the file storage includes the application type of the stored files, and
the data control function unit specifies the data redundancy corresponding to the application type included in the request for the file storage with reference to the data policy storage region.

4. The gateway device according to claim 3, further comprising: a data policy setting unit that sets the data redundancy corresponding to the application type for the data storage region according to the operation of an operator.

5. The gateway device according to claim 1, further comprising: a data index storage region that stores a data index including at least identification information on file, and identification information on the one or plurality of file server clusters that store the file,
wherein, upon receiving the request for the file read including the identification information on the file to be read, the data control function unit specifies the file server cluster in which the file to be read is stored with reference to the data index storage region, and transmits the request to the one or plurality of specified file server clusters, and reads the file to be read.

6. The gateway device according to claim 5, further comprising: a data policy storage region in which determination information indicative of whether to need the read majority determination is set,
wherein, upon receiving the request for the file read, if the determination information on the data policy storage region is indicative of the read majority determination, the data control function unit transmits the request to the plurality of specified file server clusters, and checks the identity of the files acquired from the plurality of file server clusters to determine that the read is completed if a large number of identical files are present.

7. The gateway device according to claim 1, further comprising: a data index storage region that stores a data index including at least identification information on file, and identification information on the one or plurality of file server clusters that store the file,
wherein, upon receiving the request for the file deletion including the identification information on the file to be deleted, the data control function unit specifies the file server cluster in which the file to be deleted is stored with reference to the data index storage region, and transmits the request to the one or plurality of specified file server clusters, and deletes the file to be deleted.

8. The gateway device according to claim 1, further comprising: a data index storage region that stores a data index including identification information on the file, and file information including at least any one of a size of the file, an application type, and updated date,
wherein, upon receiving the request for the file search including the search condition from the client device, the data control function unit searches the data index storage region of the subject gateway device, and returns file identification information and/or file information on the file that satisfies the condition to the client device.

9. The gateway device according to claim 8, wherein, when the data control function unit stores the file in the respective file server clusters upon receiving the request for the file storage, the data control function unit stores the identification information on the file, the identification information on the respective stored file server clusters, the size of the file, and the application type, and the updated data in the data index storage region.

10. The gateway device according to claim 1, further comprising: a data restore function unit that, in the first file server cluster in which a duration determined to be in an abnormal status by the health check function unit exceeds a predetermined threshold value, acquires and copies the same file as that stored in the first file server cluster from a second file server cluster or another device, and stores the copied file in a third file server cluster to satisfy the data redundancy of the file stored in the first file server cluster.

11. The gateway device according to claim 1,
wherein the distributed file system includes a fourth file server cluster in which the file has been already stored, and one or a plurality of fifth file server clusters in which the file is not stored or which is newly installed,
the gateway device further includes a cluster reconfiguration function unit that acquires and copies the file and metadata in the fourth file server cluster, and stores the copied file and metadata in any one of the fifth file server clusters.

12. The gateway device according to claim 11,
wherein the cluster reconfiguration function unit copies the file according to the data redundancy of the file acquired from the fourth file server cluster, and stores the copied file in the fifth file server cluster.

13. A file server system comprising:
a distributed file system having a plurality of file server clusters that perform any one of file storage, file read, and file deletion according to a request,
a gateway device that mediates requests between a client device that transmits the request including any one of file storage, file read, and file deletion, and the distributed file system
wherein the gateway device comprising:
a health check function unit that monitors an operating status of the file server cluster; and
a data control function unit that receives the request for the distributed file system from the client device, and selects one or more of the file server clusters that are normally in operation, and distributes the request to the selected file server clusters.

14. A file distribution method in a file server system, the file server system comprising:
a distributed file system having a plurality of file server clusters that perform any one of file storage, file read, and file deletion according to a request,
a gateway device that mediates requests between a client device that transmits the request including any one of file storage, file read, and file deletion, and the distributed file system
wherein the gateway device
monitors an operating status of the file server cluster, and
receives the request for the distributed file system from the client device, and selects one or more of the file server clusters that are normally in operation, and distributes the request to the selected file server clusters.
